(19) United States
(12) Patent Application Publication
(10) Pub. No.: US 2021/0010357 A1
(43) Pub. Date: Jan. 14, 2021

(54) METHOD FOR DEVELOPING A HYDROCARBON RESERVOIR BY INJECTING A GAS IN THE FORM OF FOAM

(71) Applicant: IFP Energies nouvelles, Rueil-Malmaison Cedex (FR)

(72) Inventors: Antoine SOULAT, RUEIL-MALMAISON CEDEX (FR); Frederic DOUARCHE, RUEIL-MALMAISON CEDEX (FR)

(21) Appl. No.: 16/926,245

(22) Filed: Jul. 10, 2020

(30) Foreign Application Priority Data
Jul. 12, 2019 (EP) 19305937.5

(51) Int. Cl. E21B 43/16; E21B 47/06

(52) U.S. Cl. CPC E21B 43/168; E21B 2200/20; E21B 47/06

(57) ABSTRACT

A method of developing a hydrocarbon reservoir by injecting an aqueous solution containing a gas in the form of foam into an injection well. A first step determines a foam displacement model for a flow simulator which is a function of a gas mobility reduction factor and of at least one injection rate-dependent interpolation function. A second step determines a productivity index corrected for the shear thinning effects of the foam in the cells traversed by the injection well, from a productivity index determined by assuming that the aqueous solution containing the gas in foam form is a Newtonian fluid, and a correction factor that is a function of at least one characteristic of the aqueous solution containing the gas in foam form.

### CROSS-REFERENCE TO RELATED APPLICATION

Reference is made to European Patent Application No. 19305937.5, filed Jul. 12, 2019, the contents of which is incorporated herein by reference in its entirety.

### BACKGROUND OF THE INVENTION

### Field of the Invention

The present invention relates to the exploitation of a fluid contained in an underground formation and more particularly to the enhanced recovery of such a fluid, such as a hydrocarbon fluid, using foam injection.

### Description of the Prior Art

Development of a petroleum reservoir by primary recovery extracts, via a so-called production well, the oil present in the reservoir through the overpressure naturally prevailing within the reservoir. This primary recovery only enables access to a small amount of the oil contained in the reservoir, of the order of 10% to 15% at most.

To enable the continuation of oil extraction, secondary production methods are implemented when the reservoir pressure becomes insufficient to displace the oil still in place. Notably, a fluid is injected (reinjection of produced water, diluted or not, seawater or river water injection, or gas injection for example) into the hydrocarbon reservoir to exert within the reservoir an overpressure likely to cause the oil to flow into the production well(s). A usual technique in this context is water injection, also referred to as waterflooding, where large volumes of water are injected under pressure into the reservoir via injection wells. The injected water drives part of the oil encountered and pushes it towards one or more production wells. Secondary production methods such as waterflooding however allow only a relatively small part of the hydrocarbons in place to be extracted (typically of the order of 30%). This partial sweep is notably due to oil entrapment by capillary forces, to viscosity and density differences between the injected fluid and the hydrocarbons in place, and to heterogeneities at microscopic or macroscopic scales (pore scale and reservoir scale).

There are various techniques known as enhanced oil recovery (EOR) techniques intended to enable recovery of the rest of the oil that remains in underground formations after implementing primary and secondary production methods. Examples thereof are techniques similar to those using the aforementioned waterflooding, but using a water comprising additives such as, for example, water-soluble surfactants (referred to as surfactant flooding). Using such surfactants notably induces a decrease in the water/oil interfacial tension, which provides more efficient entrainment of the oil trapped at pore constrictions.

Another known technique is enhanced recovery by injection of gases, miscible or not (natural gas, nitrogen or CO₂). This technique allows maintaining the pressure in the oil reservoir during development, and it can also allow, in the case of miscible gases, to mobilize the hydrocarbons in place and thus to improve the flow rate thereof. A commonly used gas is carbon dioxide when it is available at low cost.

There are also alternative techniques based on the injection of foam into the oil reservoir. This foam results from an intimate mixture of gas and of a surfactant solution, the latter being referred to as “foaming agent” hereafter. Due to its high apparent viscosity, foam is considered as an alternative to gas as the injection fluid employed in hydrocarbon reservoirs. The mobility of foam (the mobility of a fluid is defined as the ratio of the relative permeability of the fluid to the dynamic viscosity thereof) is thus reduced in relation to gas, which tends to segregate and to rapidly break through to production wells, notably in heterogeneous and/or thick reservoirs. Enhanced recovery using foam injection is particularly attractive because it requires injection of smaller volumes than other enhanced recovery methods using non-foaming fluids.

### BACKGROUND OF THE INVENTION

The following documents are mentioned in the description hereafter:
Beunat V., Batôt G., Gland N., Pannacci N., Chevallier E., Cuenca A. (2019). Influence of Wettability and Oil Saturation on the Rheological Behavior of CO2-Foams. Presented at the EAGE 20th European Symposium on Improved Oil Recovery.
Gassara O., Douarche F., Braconnier B., Bourbiaux B. (2017), Equivalence Between Semi-empirical and Population-Balance Foam Models. Transport in Porous Media. 120: 473. https://doi.org/10.1007/s11242-017-0935-8
Gassara O., Douarche F., Braconnier B., Bourbiaux B. (2019). Calibrating and Scaling Semi-empirical Foam Flow Models for the Assessment of Foam-Based EOR Processes (in Heterogeneous Reservoirs). Transport in Porous Media. https://doi.org/10.1007/s11242-018-01223-5
Leeftink, T., Latooij, C., & Rossen, W. (2015). Injectivity Errors in Simulation of Foam EOR. Journal of Petroleum Science and Engineering, 126, 26-34.
Peaceman, D. (1978). Interpretation of Well-Block Pressures in Numerical Reservoir Simulation. Society of Petroleum Engineers Journal, 18(03), 183-194.
van Poolen, H., Bixel, H., & Jargon, J. (1970). Individual Well Pressures in Reservoir Modeling. Oil and Gas Journal, 78-80.
van Poolen, H., Breitenbach, E., & Thurnau, D. (1968). Treatment of Individual Wells and Grids in Reservoir Modeling. Society of Petroleum Engineers Journal, 341-346.

Petroleum development of a reservoir determines the zones of the reservoir with the best oil potential, defining development schemes for these zones (in order to define the recovery type, the number and the positions of the development wells enabling optimal hydrocarbon recovery), drilling development wells and, more generally, setting up the necessary production infrastructures for reservoir development.

In the case of enhanced recovery using foam injection, defining an oil reservoir development scheme may require numerical simulation, as realistic as possible, of the flows in the presence of foam in the reservoir being considered. Such a simulation is carried out by a flow simulator comprising a foam displacement model.

Such a model can require evaluation of the performance of the foam in terms of mobility reduction. In general, this estimation involves laboratory experiments that measure the pressure drops upon the displacement of foam on the one hand, of water and non-foaming gas on the other, in an oil reservoir sample. This foam displacement model, representative of the flows at laboratory scale, is then calibrated at reservoir scale prior to perform the numerical flow simulations in order to predict the benefit provided by the injection of foam in terms of improvement in the displacement efficiency of the fluids in place.

Patent application EP-18,305,032 corresponding to U.S. patent application Ser. No. 15/887,498 describes a method concerning a calibration of the foam displacement model. The flow of the foam in a reservoir can thus be reliably predicted by numerical simulation.

However, the foams used in this context are “shear thinning”, that is their viscosity decreases with high flow velocity gradients. These flow velocities or velocity gradients are generally very high near an injection well, therefore high spatial resolution grids are required to simulate them in a realistic manner by numerical simulation. If not so, in other words, if the resolution of the grid is insufficient to reliably simulate near-well flows, there is a risk of underestimation of the near-well fluid velocity, which may lead to a misestimation of the mobility reduction of the injected fluids, and therefore to a misestimation of the formulations injectivity. In practice, predictions resulting from simulations biased by this effect underestimate the performances of the method being considered (greatly underestimated injected foam volume for example). Injectivity is understood to be the injection capacity of a well for a given fluid under imposed operating conditions in terms of pressure and/or flow rate.

More precisely, in the case of foam having shear thinning properties, a numerical flow simulation carried out using a grid of insufficient resolution at well scale may lead to an overestimation of the pressures in the cells where the injection wells are located (well cells). These overpressures result in degraded injectivity performances (injection rate decrease) predicted by simulation. Indeed, underestimating near-well velocities leads to locally neglecting the shear thinning behavior of the injected foam, with a negative impact on injectivity.

The document (Leeftink et al., 2015) is notably known, which highlights the scale effects on injectivity by solving analytically the problem and considering a simplified configuration. However, this document does not provide a solution applicable to numerical reservoir simulation.

### SUMMARY OF THE INVENTION

The present invention allows these drawbacks to be overcome. More precisely, the invention relates to a correction to be applied to the productivity index relative to the cells traversed by the injection wells, a productivity index that is a flow simulator input. Such a correction then allows prediction, by numerical simulation, of a reliable injectivity in the case of shear thinning foams.

The present invention relates to a method for exploiting the hydrocarbons present in a reservoir, by use of an injection of an aqueous solution containing a gas in the form of foam into at least one injection well and of a flow simulator. The flow simulator is based on a displacement model of the gas in the form of foam. the displacement model is expressed as a function of a mobility reduction functional of the gas. The functional is expressed as a function of a mobility reduction factor of the gas and at least one interpolation function of the mobility reduction factor. The interpolation function is a function of at least one parameter relative to at least one characteristic of the foam and of at least two constants with at least one parameter of the interpolation function corresponding to the injection rate of the gas.

According to the invention, from at least one sample of the formation and from a gridded representation representative of the reservoir, the method according to the invention comprises at least the following steps:

A—determining the displacement model by determining the mobility reduction factor of the gas and the constants of the interpolation function of the displacement model, from at least pressure drop measurements performed while injecting into the sample the gas in non-foaming form and the gas in foam form for values of the injection rate of the gas;

B—for each cell of the gridded representation traversed by the injection well, determining a productivity index IP corrected for the shear thinning effects of the foam in the cell according to a formula:

IP=α·IP₀

where IP₀ is a productivity index determined by assuming that the aqueous solution containing the gas in foam form is a Newtonian fluid, and α is a correction factor that is a function of at least one characteristic of the aqueous solution containing the gas in foam form; and

C—from the displacement model, the flow simulator, the gridded representation and the productivity indices determined for the cells of the gridded representation traversed by the injection well, determining a development scheme for the reservoir and exploiting the hydrocarbons.

According to an implementation of the invention, from measurements of conventional relative permeability to the gas in non-foaming form and measurements of conventional relative permeability to the aqueous phase of the solution, step A can be carried out by at least the following substeps:

i. for each of the interpolation functions, carrying out injection, into the sample, of the gas in non-foaming form and of the gas in foam form for values of the parameter relative to the function, measuring respectively a pressure drop with foam and a pressure drop without foam for each of the values of the parameter relative to the function, and determining at least one value of the parameter relative to the interpolation function maximizing a ratio between the pressure drops without foam and the pressure drops with foam measured for the function,

ii. from at least the pressure drop measurements with foam and without foam performed for the values of the parameters relative to the functions maximizing the ratio, the measurements of conventional relative permeability to the gas in non-foaming form and the measurements of conventional relative permeability to the aqueous phase, determining the mobility reduction factor and calibrating the constants of each of the interpolation functions.

According to an implementation of the invention, the foam displacement model can be expressed as:

k_{rg}^{FO}(S_{g})=FMk_{rg}(S_{g})

where k_{rg}^{FO}(S_{g}) is the relative permeability to the gas in foam form for α given gas saturation value S_{g}, k_{g}(S_{g}) is the relative permeability to the non-foaming gas for the gas saturation value S_{g}, and FM is the functional expressed as:

$$FM = \frac{1}{1 + ( {M}^{opt} - 1 ) * {Π}_{k} {F}_{k}}$$

where M^{opt} is the mobility reduction factor of the gas and Fₖ is one of the interpolation functions, with k≥1.

According to an implementation of the invention, the interpolation functions can be four in number and the parameters of the functions are foaming agent concentration, water saturation, oil saturation and the injection rate of the gas.

According to an implementation of the invention, the constants of at least one of the interpolation functions can be calibrated by use of a least-squares method, such as an inverse method based on an iterative minimization of an objective function.

According to an implementation of the invention, after step i) has been applied for each of the interpolation functions and before step ii), the gas in non-foaming form and the gas in foam form can be injected into the sample according to the values of each of the parameters maximizing the ratio, a pressure drop with foam and a pressure drop without foam can be measured respectively for all of the values of the parameters maximizing the ratio, and step ii) can be carried out from, in addition, the pressure drop measurements with and without foam performed for all of the values of the parameters maximizing the ratio.

According to an implementation of the invention, the productivity index IP₀ of the injection well can be determined with [symbol] formula.

According to an implementation of the invention, the productivity index IP₀ can be determined by assuming that the aqueous solution containing the gas in foam form is a Newtonian fluid according to the following formula:

$${IP}_{0} = \frac{2 π hk}{ln ( \frac{{r}_{o}^{′}}{{r}_{w}} )}$$

where r_{w} is the radius of the injection well, h is the height of the cell, k is the permeability of the porous medium of the reservoir and r₀′ is an equivalent radius of the cell traversed by the well in a radial-geometry gridded representation.

According to an implementation of the invention, the equivalent radius r₀′ of the cell traversed by the well can be defined as:

$$P ( r ) = {P}_{0} + \frac{μ Q}{2 π hk} ln ( \frac{r}{{r}_{0}^{′}} ) with P ( {r}_{0}^{′} ) = {P}_{0}$$

where P represents the evolution of the pressure as a function of radial distance r, P₀ is the pressure assigned to the cell traversed by the well, Q is the injection rate of the gas and μ is the viscosity of the gas.

According to an implementation of the invention, the correction factor can be expressed with the following formula:

$$α = \frac{1 + \frac{\text{?} ( \text{?} )}{{λ}_{w} ( {r}_{w} )} F M ( {r}_{w} )}{1 + \frac{{λ}_{g}}{{λ}_{w}} F M}$$

$$\text{?} \text{indicates text missing or illegible when filed}$$

where λ_{g} is a mobility associated with the gas phase, λ_{w} is a mobility associated With the aqueous phase, r_{w} is the radius of the well, FM(r_{w}) is the gas mobility reduction functional to the radius of the well, and

$$\overline{\frac{{λ}_{g}}{{λ}_{\text{?}}} F M}$$

$$\text{?} \text{indicates text missing or illegible when filed}$$

is the average of the product of the mobility reduction functional of the gas by the ratio of the mobilities associated with the gas phase and the aqueous phase, the average being estimated in the cell traversed by the well.

According to an implementation of the invention, the correction factor can be expressed with the formula:

$$α = \frac{1 + \frac{{f}_{\text{?}}}{1 - {f}_{g}}}{1 + \overline{\frac{{λ}_{g}}{{λ}_{w}} F M}}$$

$$\text{?} \text{indicates text missing or illegible when filed}$$

where λ_{g} is a mobility associated with the gas phase, λ_{w} is a mobility associated with the aqueous phase,

$$\overline{\frac{{λ}_{g}}{{λ}_{w}} F M}$$

is the average of the product of the mobility reduction functional of the gas by the ratio of the mobilities associated with the gas phase and the aqueous phase, the average being estimated in the cell traversed by the well, and ƒ_{g} is the quality of the foam.

According to an implementation of the invention, the correction factor can be expressed with the formula:

$$α = 1 + \frac{{f}_{g}}{1 - {f}_{g}}$$

where ƒ_{g} is the quality of the foam.

Furthermore, the invention relates to at least one of a computer program product downloadable from a communication network and at least one of recorded on a computer-readable medium and processor executable, comprising program code instructions for implementing the method as described above, when the program is executed on a computer.

### BRIEF DESCRIPTION OF THE DRAWINGS

Other features and advantages of the method according to the invention will be clear from reading the description hereafter of embodiments given by way of non limitative example, with reference to the accompanying figures wherein:

FIG. 1 shows gas, water and oil relative permeability curves relative to an example of application of the method according to the invention;

FIG. 2 shows an evolution over time of the bottomhole gas phase flow velocities, estimated with a first grid and a second grid; and

FIG. 3 shows curves presenting the evolution over time of the bottomhole pressure in the injection well, obtained with a productivity index determined according to the prior art and according to an implementation of the invention, as well as a reference curve of the evolution over time of the bottomhole pressure in the injection well.

### DETAILED DESCRIPTION OF THE INVENTION

In general terms, the invention concerns a method for developing a reservoir comprising hydrocarbons by injecting an aqueous solution containing a gas in a foam form into at least one injection well, and notably by determining a scheme for exploiting the hydrocarbons of the reservoir studied by use of a flow simulator.

In particular, the method according to the invention determines, from laboratory measurements, a displacement model for the gas in foam form, and a correction to be applied to the productivity index of the injection well, the foam displacement model and the productivity index being flow simulator inputs.

The following definitions are used:
Foam: it is a phase dispersed in another phase by addition of a foaming agent to one of the two phases. One of the phases can be an aqueous solution and the other phase is a gas, such as natural gas, nitrogen or CO₂. The flow of foam in a porous medium is macroscopically (at the scale of a sample such as a core) comparable to the flow of a single homogeneous phase obeying Darcy's law for single phase flows but whose viscosity, referred to as “apparent viscosity” hereafter, is well above (of the order of 100 to 1000 times as high, or even more) that of the gas it is essentially made up of. The foaming agent can be a surfactant,
Foam quality: it is the ratio of the gas flow rate u_{g} to the total flow rate of solution+gas. If the solution is an aqueous solution injected at a rate u_{w}, foam quality ƒ_{g} can be expressed as:

$${f}_{g} = \frac{{u}_{g}}{( {u}_{g} + {u}_{w} )}$$

Thus defined, the respective flow rates of the solution and of the gas determine a value ƒ_{g} for the quality of the foam,
Productivity index of a well is the ratio of the total flow rate under surface conditions to the pressure drop between the well bottom and the reservoir. This quantity is commonly used in the field and it reflects the potential of a well. For an injection well, this index describes the fluid(s) intake capacity of the well under given pressure and/or flow rate conditions, that is its injectivity.

The method according to the invention requires:
a sample of the underground formation being studied, obtained by in-situ coring for example,
a flow simulator based on a displacement model of the gas in a foam form (see below),
measurements of conventional relative permeability to the gas in non-foaming form and measurements of conventional relative permeability to the aqueous phase: it can be measurements performed specially for the method according to the invention (those who have thorough knowledge of the way such laboratory experiments should be conducted), but it can also be pre-established curves, or analytic functions calibrated from known correlations.

The method according to the invention requires a flow simulator comprising a foam displacement model. According to the invention, the foam displacement model is based on the assumption that the mobility of the gas present in a foam form is reduced by a given factor under fixed formation and foam flow conditions. The formulation of such a model, used by many flow simulators, is a modification of the gas relative permeabilities alone when the gas is present in foam form, which is expressed with a formula of the following type for a given gas saturation S_{g}:

k_{rg}^{FO}(S_{g})=FMk_{rg}(S_{g}) (1)

where k_{rg}^{FO}(S_{g}) is the relative permeability to gas in foam form, expressed as the product of a function FM by the relative permeability to the non-foaming gas k_{g}(S_{g}) for the same gas saturation value S_{g} (denoted by S_{g}^{FO} hereafter). An assumption underlying the current foam models is that the relative water (or liquid, by extension) permeability is supposed to be unchanged, whether the gas is present as a continuous phase or as foam. Under this assumption, the gas mobility reduction functional denoted by FM hereafter is expressed by a formula:

$$F M = \frac{1}{1 + ( {M}_{m o d}^{opt} - 1 ) * {\prod }_{k} {F}_{k} ( {V}_{k} )} \qquad ( 2 )$$

where:

M_{mod}^{opt} is a mobility reduction factor (referred to as “optimal” hereafter), corresponding to the ratio of the gas (k_{rg}) and foam (k_{rg}^{FO}) relative permeabilities under conditions (referred to as “optimal” hereafter) allowing the gas mobility to be reduced, for conditions where the value of terms Fₖ(Vₖ) defined below is 1, that is:

$${M}_{m o d}^{o p t} = \frac{{k}_{r g} ( {S}_{g , opt}^{FO} )}{{k}_{r g}^{FO} ( {S}_{g , opt}^{FO} )} = \frac{1}{F {M}_{o p t}} \qquad ( 3 )$$

terms Fₖ(Vₖ) (with k equal to or greater than 1) are the values of the interpolation functions Fₖ of the mobility reduction factor between value M_{mod}^{opt} and 1, which depend each on a parameter Vₖ relative to at least one characteristic of the foam, and which involve calibration constants to be calibrated as explained below. Conventionally, parameter Vₖ can notably be the foaming agent of concentration Cₛ^{w}, the water saturation S_{w}, the oil saturation Sₒ or the gas flow rate u_{g}.

According to the invention, the foam displacement model comprises at least one interpolation function (conventionally denoted by F₄) depending on a parameter corresponding to the injection rate (conventionally denoted by V₄). According to an implementation of the invention, interpolation function F₄ is written with a formula of the type:

$${F}_{4} = {( \frac{{N}_{c}^{*}}{Max ( {N}_{c} , {N}_{c}^{*} )} )}^{{e}_{c}} \qquad ( 4 )$$

where:

N_{c} is a dimensionless number expressing the ratio between viscous forces (related to the gas flow) and capillary forces at local scale. This ratio can for example be defined with a formula:

$${N}_{c} = \frac{{μ}_{g} {u}_{g}}{φ {σ}_{w g} ( {C}_{s}^{w} )} = \frac{{μ}_{g} {f}_{g} {u}_{t}}{φ {σ}_{w g} ( {C}_{s}^{w} )}$$

The variables involved in the calculation of N_{c} are porosity ϕ, foam quality ƒ_{g}, flow velocity uₜ (total velocity of the two constituent phases of the foam), water-gas interfacial tension α_{gw} (which is a function of the foaming agent concentration Cₛ^{w} of the aqueous phase), and gas viscosity μ_{g}. Exponent e_{c} is a constant to be calibrated,
N_{c}* is the reference value of capillary number N_{c}, calculated for the reference pressure gradient (equal to the applied minimum gradient ∇Pₘᵢₙ allowing foam to be generated in a porous medium), that is for the minimum quality allowing foam to be generated, that is:

$${N}_{c}^{*} = \frac{{μ}_{g} {f}_{g}^{m i n} {u}_{t}}{φ ( {f}_{g}^{m i n} ) {σ}_{wg} ( {C}_{s}^{w} )} .$$

Thus, according to the invention, the constants of the foam displacement model to be determined are at least the optimal mobility reduction factor M_{mod}^{opt} as defined according to Equations (2) and (3), constant N_{c}* and constant e_{c}. It is important to calibrate the foam displacement model as a function of the injection rate because, otherwise, the apparent viscosity of the foam does not decrease near the injection wells, where high velocity gradients (shear thinning character of the foam) prevail, which may lead to underestimating the performances of the method considered (injected foam volume greatly underestimated for example).

According to an embodiment of the invention, the gas mobility reduction functional, denoted by FM, can comprise four interpolation functions Fₖ(Vₖ) and each of these functions comprises two constants to be calibrated from experimental data. According to an embodiment of the invention wherein the gas mobility reduction functional comprises four interpolation functions Fₖ(Vₖ), differentiations can be defined:
interpolation function F₁ relative to parameter V₁=Cₛ^{w} (foaming agent concentration Cₛ^{w}) by a formula:

$${F}_{1} = {( \frac{Min ( {C}_{s}^{w} , {C}_{s}^{w \text{-} ref} )}{{C}_{s}^{w \text{-} ref}} )}^{{e}_{s}} \qquad ( 5 )$$

for which the constants to be calibrated are exponent eₛ and constant Cₛ^{w-ref} that corresponds to the foaming agent concentration under optimal reference conditions,
interpolation function F₂ relative to parameter V₂=S_{w} (water saturation), by a formula of the type:

$${F}_{2} = [ 0 .5 + \frac{arctan [ {f}_{w} ( {S}_{w} - {S}_{w}^{*} ) ]}{π} ] \qquad ( 6 )$$

for which the constants to be determined are constant ƒ_{w}, which governs the transition (as a function of the water saturation) between the foaming and non-foaming states, and constant S_{w}*, which represents the transition water saturation between stable and unstable foaming states,
interpolation function F₃ relative to parameter V₃=Sₒ (oil saturation) by a formula:

$${F}_{3} = {( \frac{Max [ 0 ; {S}_{o}^{*} - {S}_{o} ]}{{S}_{o}^{*}} )}^{{e}_{o}} \qquad ( 7 )$$

where Sₒ* is the oil saturation beyond which the foam loses all its abilities to reduce the gas mobility, and exponent eₒ is a constant to be determined,
interpolation function F₄ relative to parameter V₄=u_{g} (gas flow rate), as defined above (see Equation (4) above) and for which constant N_{c}* and constant e_{c} need to be determined.

In general terms, it can be shown that any interpolation function Fₖ of parameter Vₖ can be written in the form:

$${F}_{k} ( {V}_{k} ) = \frac{\frac{1}{F M} - 1}{\frac{1}{F {M}_{opt}} - 1} = \frac{{M}_{mod} ( {V}_{k} ) - 1}{{M}_{mod}^{opt} - 1} \qquad ( 8 )$$

where M_{mod}(Vₖ) is the mobility reduction for a value Vₖ of parameter k impacting the foam (and for optimal values of the other parameters Vⱼ, j being different from k) and where M_{mod}^{opt}=M_{mod}(Vₖ^{opt}) is the mobility reduction obtained for the optimal value Vₖ^{opt} of parameter Vₖ. The method according to the invention thus is, for each parameter Vₖ impacting the foam, in determining factors M_{mod}(Vₖ) for different values of this parameter, as well as M_{mod}^{opt}, then in determining, from these factors, the constants of the interpolation function Fₖ being considered.

According to an embodiment of the invention where functional FM defined in Equation (2) involves interpolations functions F₁, F₂, F₃ and F₄ defined in Equations (4′) to (4), determining the foam displacement model may require calibrating the 8 constants as follows: Cₛ^{w-ref}, eₛ, ƒ_{w}, S_{w}*., Sₒ*, eₒ, N_{c}^{ref}, e_{c}.

According to the invention, determining the constants of interpolation functions Fₖ involved in Equation (2) is achieved by performing a calibration interpolation function by interpolation function (and not globally, for all of the functions), from experimental measurements relative to each interpolation function, performed under the optimal conditions established for the other interpolation functions.

Conventionally, the flow simulator according to the invention requires the input of a gridded representation representative of the reservoir, also referred to as reservoir grid or reservoir model. It is a model of the subsoil, constructed in order to describe as precisely as possible the structure, the petrophysical properties and the properties of the fluids of the reservoir being studied. This model is generally represented in a computer and is a grid or mesh pattern. Each cell of the grid comprises one or more property values relative to the reservoir being studied (such as porosity, permeability, saturation, geological facies, pressure, etc.). A reservoir model needs to verify as much as possible the properties collected in the field: log data measured along wells, measurements performed on rock samples taken by core drilling for example, data deduced from seismic acquisition surveys, production data such as oil and water flow rates, pressure variations, etc. The reservoir simulation specialists are fully aware of methods for constructing such a gridded representation of a geological reservoir. It is noted that the reservoir model can merge with the geological model when the computing power is sufficient to enable numerical flow simulation computations on a fine grid. In the opposite case, an upscaling method is used in order to substitute a fine grid model (the geological model) with a coarse-grid model (the reservoir model). This upscaling step can be carried out using for example the CobraFlow™ software (IFP Energies nouvelles, France).

The method according to the invention comprises at least the following steps:

1. Laboratory measurements relative to an interpolation function
1.1 Defining values of the parameter relative to the interpolation function
1.2 Injections with/without foam and pressure drop measurements
1.3 Determining an optimal parameter value

2. Determining an optimal mobility reduction factor relative to the laboratory measurements under optimal conditions

3. Determining the foam displacement model
3.1 Determining the optimal mobility reduction factor
3.2 Calibration of the constants of the interpolation functions

4. Determining a productivity index corrected for the shear thinning effects of the foam
4.1 Determining a productivity index under the assumption of a Newtonian fluid
4.2 Correction of the shear thinning effects of the foam

5. Exploiting the hydrocarbons of the reservoir.

Step 1 is carried out at least for interpolation function F₄ relative to the injection rate and can be repeated for each interpolation function of the foam displacement model. Step 4 is carried out for at least one of the injection wells traversing the reservoir.

The various steps of the method according to the invention are detailed hereafter.

1. Laboratory Measurements Relative to an Interpolation Function

The first step of the method according to the invention is described hereafter in the most general case, that is for any interpolation function Fₖ. However, according to the invention, this step is at least carried out for interpolation function F₄, which depends on parameter V₄ corresponding to the gas injection rate.

According to an embodiment of the invention, this step can be repeated for each interpolation function involved in the foam displacement model defined according to Equations (1) and (2).

In general, this step is applied to each interpolation function independently of one another. At first, a plurality of values are defined for the parameter relative to the interpolation function being considered, then an injection is performed, into the sample, with gas in non-foaming form and gas in foamed form according to the values of the parameter relative to the interpolation function being considered, and a pressure drop with foam and a pressure drop without foam are respectively measured for each value of the parameter relative to this function. This step is detailed hereafter for a given interpolation function Fₖ, and it is at least applied for interpolation function F₄ relative to the injection rate.

1.1 Defining Values of the Parameter Relative to the Interpolation Function

This substep defines a plurality of values V_{k,i} (with i ranging between 1 and I, and I>1) for characteristic parameter Vₖ of the interpolation function Fₖ being considered.

According to an embodiment of the invention, it can define a range of values for this parameter and a sampling interval for this range.

According to an embodiment of the invention, the values of parameter Vₖ relative to the interpolation function Fₖ being considered can be defined among the possible or realistic values of the parameter being considered (for example, a foaming agent mass concentration below 1% in all cases), so as to sample in an ad hoc manner the representative curve of the interpolation function being considered (an interpolation function with linear behavior does not need a large number of measurements, unlike other types of functions). The foam-injection enhanced oil recovery requires thorough knowledge of the way to define a plurality of ad hoc values for the parameters of each interpolation function Fₖ.

For example according to the invention, for the measurements relative to interpolation function F₄ (see Equation (4)), a rate of injection into the core ranging between 10 and 40 cm³/h, with an interval of 10 cm³/h, is selected.

1.2 Injections with/without Foam and Pressure Drop Measurements

This substep carries out at least two series of experiments on at least one sample of the underground formation for the interpolation function Fₖ being considered:
Injection of gas in non-foaming form (more precisely, co-injection of water and gas in non-foaming form) into the sample considered for each value Vₖ of parameter Vₖ relative to the function Fₖ being considered. The gas and water injection rates adopted for each of these co-injections are the same as the rates of the water and the gas injected in foam form in the tests following these co-injections. According to the invention, in the case of interpolation function F₄ of Equation (4), only the flow rate in the sample being considered is varied, while the parameters of the other interpolation functions F₁, F₂, F₃ (for example, the foaming agent concentration, the foam quality and the oil saturation) are fixed. During each experiment of this first series, a pressure drop (i.e. a difference in pressure) is measured, which is denoted by Δp_{k,i}^{NOFO}, for each value V_{k,i}.
Foam injection: the same experiment is repeated, for the same values of the parameter being considered (and at least, according to the invention, for the same injection rate values), but by injecting this time the water and the gas in foam form. During each experiment of this second series, a pressure drop (that is a difference in pressure) is measured, which is denoted by ΔP_{k,i}^{FO} for each value V_{k,i}.

According to an embodiment of the invention, the injections of gas in non-foaming form and in foam form are performed on formation samples initially saturated with a liquid phase (such as at least one of water and oil), which may be mobile or residual depending on the case history of the core sample and the measurement objectives (gas mobility control in secondary or tertiary injection, after water injection). The displacements studied are then drainage processes wherein the saturation of the gas phase increases in all cases.

According to a variant embodiment of the invention, it is possible to measure, in addition to the pressure drops, the liquid phase (at least one of water and oil) and gas productions, and possibly the gas saturation profiles during the transient displacement period and in the steady state. These optional measurements allow the model to be validated once the interpolation functions Fₖ are calibrated.

According to an implementation of the invention, the foaming agent selected for implementing the invention is dissolved in an aqueous solution at a fixed concentration, of the order of 1 g/I for example. The solution thus prepared and the gas (CO₂ for example) are injected into the rock sample. According to the invention, the injections are performed at least for different injection rate values.

According to an implementation of the invention, the experimental setup described in the document (Beunat et al, 2019) can be used. This experimental setup was designed to perform measurements on core samples. It comprises three dual-piston Vindum pumps used for injecting fluids into the porous mass at constant rates. The first pump injects liquids (brine or surfactant solution), the second pump allows the porous medium to be filled with oil and the third pump allows the gas to be injected using a transfer cell. The outlet gas flow rate is measured by a gas flow meter. According to this implementation of the invention, the sample is placed in a vertical cell. The fluids are then injected into the sample through the top. The fluid flow rate in the sample is maintained by confining pressure. The pore pressure is controlled by use of a back-pressure regulating valve connected to the cell outlet. Differential pressure transducers allow measuring levels up to 20 bars. According to this implementation of the invention, the co-injection of surfactant solution and gas is performed at the T junction at the injection head. In this configuration, the foam forms in situ. Such a setup allows to control the foam quality ƒ_{g} by controlling the flow rates of the water and gas phases. Thus, the experimental setup according to this embodiment of the invention allows performing measurements at a constant quality level (under steady state conditions). It is recommended to operate at constant quality to study the velocity effects on the apparent viscosity of a foam, because small variations in the foam quality can have a strong impact on the apparent viscosity estimation as described in Gassara et al, 2017.

1.3 Determining an Optimal Parameter Value

This substep determines the value Vₖ^{opt}, which is referred to as optimal value hereafter, maximizing the ratio between the pressure drops without foam Δp_{k,i}^{NOFO} and the pressure drops with foam ΔP_{k,i}^{FO} relative to the interpolation function Fₖ being considered and measured in the previous substep. Thus, if M_{lab}^{k,i} denotes the ratio of the pressure drops measured in the presence and in the absence of foam for value V_{k,i} of parameter Vₖ, that is

$${M}_{lab}^{k , i} = \frac{Δ {P}_{k , i}^{FO}}{Δ {P}_{k , i}^{N O F O}} = \frac{{k}_{r g} ( {S}_{g ( k , i )}^{NOFO} )}{{k}_{r g}^{F O} ( {S}_{g ( k , i )}^{F O} )} ,$$

then optimal value Vₖ^{opt} can be defined, like value V_{k,i}, which maximizes M_{lab}^{k,i} whose value is then expressed as follows:

$${M}_{lab}^{k , iopt} = {M}_{lab}^{kopt} = {Max}_{i} {M}_{lab}^{k , i} \qquad ( 9 )$$

According to the invention, step 1 as described above is applied at least for interpolation function F₄ relative to the injection rate. According to an embodiment of the invention, step 1 as described above can be repeated for each parameter Vₖ relative to each interpolation function Fₖ considered for implementing the method according to the invention. Thus, after such a repetition, an optimal value Vₖ^{opt} is obtained for each parameter Vₖ.

All of the values Vₖ^{opt} determined at the end of step 1 are referred to as “optimal conditions” hereafter, and they are possibly repeated for each interpolation function being considered for implementing the method according to the invention.

According to an implementation of the invention where the foam displacement model can involve only interpolation function F₄ as defined by Equation (4) above, the optimal conditions described above correspond to value V₄, of parameter V₄ maximizing the ratio of the pressure drops measured in the presence and in the absence of foam as described in substep 1.2.

2. Determining an Optimal Mobility Reduction Factor Relative to the Laboratory Measurements Under Optimal Conditions

According to an implementation of the invention where the foam displacement model involves at least two interpolation functions (in other words, at least one interpolation function in addition to interpolation function F₄), this step performs injections of gas in non-foaming form and gas in foam form (similar to substep 1.2), but this time under the so-called “optimal” conditions determined at the end of substep 1.3. It is noted that substep 1.3 is possibly repeated for each interpolation function considered for the definition of the foam displacement model. More precisely, the following measurements are performed:
Gas is injected in non-foaming form (more precisely, co-injection of water and gas in non-foaming form) into the sample being considered. This injection is carried out under the optimal conditions (defined by all of the optimal values Vₖ^{opt} determined for each parameter Vₖ determined at the end of step 1, and at least for parameter V₄). During this first experiment, a pressure drop (that is a difference in pressure) is measured, which is denoted by ΔPₒₚₜ^{NOFO} hereafter,
Foam is injected (that is injection of gas and water, with addition of a foaming agent to one of the water or gas phases) into the sample being considered. This injection is carried out under the optimal conditions (defined by all of the optimal values Vₖ^{opt} determined for each parameter Vₖ, and at least for parameter V₄) determined at the end of step 1. During this second experiment, a pressure drop (i.e. a difference in pressure) is measured, which is denoted by ΔPₒₚₜ^{FO}, hereafter.

M_{lab}^{opt} denotes hereafter the so-called “optimal” mobility reduction factor relative to the laboratory measurements under the so-called “optimal” conditions, defined by a formula of the type:

$${M}_{lab}^{opt} = \frac{Δ {P}_{opt}^{FO}}{Δ {P}_{opt}^{NOFO}} = \frac{{k}_{rg} ( {S}_{g , opt}^{NOFO} )}{{k}_{rg}^{F O} ( {S}_{g , opt}^{FO} )} . \qquad ( 10 )$$

According to an implementation of the invention where the foam displacement model involves only interpolation function F₄ as defined by Equation (4) above, the (so-called “optimal”) mobility reduction factor relative to the laboratory measurements under optimal conditions corresponds to the maximum value of the ratio of the pressure drops measured in the presence and in the absence of foam as described in substep 1.2. No additional measurement is therefore required for this implementation of the invention.

3. Determining the Parameters of the Foam Displacement Model

This step determines the parameters of a foam displacement model that is a function of at least the “optimal” gas mobility reduction factor and of at least interpolation function F₄ relative to the injection rate (see Equations (1), (2), (3) and (4) described above). This step is however described in the most general case, for any function Fₖ.

3.1 Determining the Optimal Mobility Reduction Factor

This substep determines, from the pressure drop measurements performed under the optimal conditions, from measurements of conventional relative permeability to the gas in non-foaming form and from measurements of conventional relative permeability to the aqueous phase, an optimal mobility reduction factor, that is the reduction factor of the relative permeabilities to the gas which, present at a given saturation in the porous medium, circulates in form of foam or in form of a continuous phase (in the presence of water).

According to an embodiment of the invention, the optimal mobility reduction factor can be determined with at least the following steps:
From the conventional relative permeabilities for the gas k_{rg} and for the aqueous phase k_{rg}, the gas saturation in permanent flow regime of gas and non-foaming water S_{g}^{NOFO} is calculated with a formula:

$${S}_{g}^{N O F O} = {( \frac{{k}_{r g}}{{k}_{rw}} )}^{- 1} ( \frac{{f}_{g}}{1 - {f}_{g}} \frac{{μ}_{g}}{{μ}_{w}} ) \qquad ( 11 )$$

where ƒ_{g} is the fractional flow of gas (ratio of the gas flow rate to the total flow rate), μ_{g} and μ_{w} are the viscosity of the gas and of the water respectively,
From the ratio of the pressure drops measured under the optimal conditions as defined at the end of step 1 (step 1 is possibly repeated for each interpolation function Fₖ considered) and from the gas saturation in permanent flow regime of gas and non-foaming water S_{g}^{NOFO}, the gas saturation in the presence of foam S_{g}^{FO} is calculated with a formula:

$${S}_{g , opt}^{F O} = 1 - {( {k}_{rw} )}^{- 1} \{ \frac{{k}_{rw} ( {S}_{w}^{N O F O} = 1 - {S}_{g}^{N O F O} )}{{M}_{l a b}^{o p t}} \} \qquad ( 12 )$$

This relationship derives from the known hypothesis of invariance of the water relative permeability functions for water flowing in form of foam films or in conventional continuous form,
From the gas saturation in permanent flow regime of gas and non-foaming water S_{g}^{NOFO} the gas saturation in the presence of foam S_{g,opt}^{FO} under the optimal conditions and factor M_{lab}^{opt} determined under the optimal conditions (see step 2), the mobility reduction factor M_{mod}^{opt} is determined according to a formula:

$${M}_{mod}^{opt} = {M}_{lab}^{opt} \frac{{k}_{r g} ( {S}_{g , opt}^{FO} )}{{k}_{r g} ( {S}_{g , opt}^{NOFO} )} \qquad ( 13 )$$

3.2 Calibration of the Constants of the Interpolation Functions

This substep calibrates the constants of each interpolation function Fₖ being considered, and at least the constants relative to interpolation function F₄ relative to the injection rate, from mobility reduction factor M_{mod}^{opt}, from the pressure drop measurements relative to the interpolation function being considered, the measurements of conventional relative permeability to the gas in non-foaming form and the measurements of conventional relative permeability to the aqueous phase.

According to an embodiment of the invention, the procedure described in substep 3.1 can be applied beforehand to the ratios of the pressure drops M_{lab}^{k,i} measured in the presence and in the absence of foam for the different values V_{k,i} of parameter Vₖ. Mobility reduction factors M_{mod}^{k,i} relative to values V_{k,i} of parameter Vₖ are thus determined with a formula:

$${M}_{mod}^{k , i} = {M}_{lab}^{k , i} \frac{{k}_{r g} ( {S}_{g ( k , i )}^{FO} )}{{k}_{r g} ( {S}_{g ( k , i )}^{NOFO} )} , \qquad ( 14 )$$

where the gas saturation in the presence of foam S_{g(k,i)}^{FO} for values V_{k,i} of parameter Vₖ is obtained with a formula:

$${S}_{g ( k , i )}^{F O} = 1 - {( {k}_{rw} )}^{- 1} \{ \frac{{k}_{rw} ( {S}_{w ( k , i )}^{N O F O} = 1 - {S}_{g ( k , i )}^{NOFO} )}{{M}_{l a b}^{k , i}} \} \qquad ( 15 )$$

Advantageously, this operation is repeated for each interpolation function Fₖ. The constants of each interpolation function Fₖ being considered are then calibrated from the optimal mobility reduction factor M_{mod}^{opt} and from the values of the mobility reduction factors M_{mod}^{k,i} relative to each interpolation function determined as described above.

According to the invention, at least the constants of function F₄ are calibrated. Notably, a value is determined for exponent e_{c} that adjusts as closely as possible the values of M_{mod}^{4,i} corresponding to values V^{4,i} of the parameter being studied (injection rate), which is formulated as follows:

$${F}_{4} ( {V}_{4 , i} ) = {( \frac{{N}_{c}^{*}}{Max ( {N}_{c , i} , {N}_{c}^{*} )} )}^{{e}_{c}} = \frac{{M}_{mod}^{4 , i} - 1}{{M}_{mod}^{opt} - 1} \qquad ( 16 )$$

According to an embodiment of the invention, this calibration, interpolation function by interpolation function, can be achieved by a least-squares method such as, for example, an inverse method based on the iterative minimization of an objective function. Those working in the field have thorough knowledge of such methods. Advantageously, implementing a least-squares method and, in particular, the iterative minimization of an objective function, is achieved using a computer.

According to another embodiment of the invention, such a calibration, interpolation function by interpolation function, can be done graphically. Those working in the field have thorough knowledge of such function constant calibration methods from a series of values of the function.

Thus, at the end of this step, a foam displacement model is obtained which is calibrated at least for the interpolation function relative to the injection rate (function F₄), and suited to be used by an ad hoc flow simulator.

4. Determining a Productivity Index Corrected for the Shear Thinning Effects of the Foam

This step determines a productivity index accounting for the shear thinning properties of the foam, for each cell of the gridded representation of the reservoir traversed by the injection well. Advantageously, this step is also repeated for each injection well of the reservoir.

A cell of the gridded representation of the reservoir traversed by an injection well is referred to as “well cell” hereafter. In flow simulation within a reservoir, the dimensions of a well cell are of the order of 50 m×50 m in a horizontal plane (and of the order of 10 m in a vertical plane), which is much greater than the real radius of a well (of the order of ten centimeters). When calculating the productivity index of a well cell according to the prior art, it is assumed that the viscosity of the injected fluid is constant in the well cell (Newtonian fluid hypothesis), which is not true for shear thinning fluids such as foam. Such an approximation leads to errors, notably when estimating the pressures in the well.

The present step is applied for each cell of the gridded representation of the reservoir traversed by an injection well, in other words, for each well cell. For a given well cell, the present step determines a first productivity index for the well cell by considering the injected fluid as a Newtonian fluid, then in applying a correction factor to this first productivity index, to determine a second productivity index accounting for the shear thinning properties of the foam. According to the invention, the correction factor is a function of at least one characteristic of the injected fluid, that is of the aqueous solution containing the gas in foam form. Advantageously, this step is repeated for each injection well of the reservoir.

4.1 Determining a Productivity Index Under the Assumption of a Newtonian Fluid

According to a first variant of the invention, the conventional Peaceman formula (see Peaceman, 1978) is used to determine a productivity index in the well cell by assuming that the fluid injected into the injection well is a Newtonian fluid. This formula can be written in the form:

$$1 {P}_{0} = \frac{2 π hk}{ln ( \frac{{r}_{0}^{′}}{{r}_{w}} )} \qquad ( 17 )$$

where r_{w} is the (real) radius of the well, h the height of the cell, k the permeability of the porous medium making up the reservoir, and r₀′ the equivalent radius of the well cell in a radial-geometry gridded representation of the reservoir. In other words, it would be the radius of the well cell if a radial-geometry grid was considered instead of a Cartesian grid which radius is also referred to as drainage radius. Physically, this productivity index is defined, except for the viscosity μ of the fluid, as the proportionality factor between the well flow rate Q and the pressure difference between the well cell pressure P₀ and the [symbol] pressure P_{f}. In other words, it is the factor allowing calculation and identification of pressure P₀ of the well cell from [symbol] pressure [symbol] according to the formula:

Q=IP₀/(P₀−P_{ƒ}) (17′)

In, practice, a flow simulator in a reservoir uses formulas (17) and (17′) to determine well cell pressure P₀, from flow rate Q, [symbol] pressure [symbol] real radius r_{w} of the well and equivalent radius r₀′.

In general terms, document [symbol] 1978) defines an equivalent radius r₀′ such that the evolution of pressure P as a function of radial distance r is expressed as:

$$P ( r ) = {P}_{0} + \frac{μ Q}{2 π hk} ln ( \frac{r}{{r}_{0}^{′}} ) with P ( {r}_{0}^{′} ) = {P}_{0}$$

where P₀ is the pressure assigned to the well cell, Q is the injection rate and μ is the viscosity of the injected fluid.

According to an implementation of the invention, in the case of a Cartesian grid having cells of dimensions Δx and Δy in a horizontal plane, equivalent radius r₀′ can be determined according to the formula:

r₀′=0.14\sqrt{Δx²+Δy²}

According to on implementation of the invention, in the case of a (2D or 3D) Cartesian grid made up of square cells and in the case of a 5-point numerical scheme; r₀′ can be written

$${r}_{0}^{′} = {e}^{- \frac{π}{2}} Δ x ,$$

where Δx is the space interval of the regular grid in a horizontal plane.

According to an implementation of the invention, in the case of a (2D or 3D) Cartesian grid mode up of square cells and in the case of a 9-point scheme, r₀′ can be written r₀′=αΔx, where Δx is the |space interval of the regular grid in a horizontal plane and a is a number that can be calculated according to the cross-sectional area of flow of the diagonal connections. For example, if the side of the flow cross-section of the diagonal connections is equal to the diagonal of the square cell of side Δx, a can be calculated as

$$a = \text{?} \text{?} \approx 0.542 . \\ \text{?} \text{indicates text missing or illegible when filed}$$

According to a second variant of the invention, the productivity index in the well cell can be determined by taking the average of the pressure in the well cell under radial flow conditions, as described in documents (van Poolen et al, 1968; van Poolen et al, 1970).

4.2 Correction of the Shear Thinning Effects of the Foam

According to the invention, a correction factor to be applied to the productivity index determined in the above substep, by considering the injected fluid as a Newtonian fluid, is determined to account for the shear thinning properties of the foam. In other words, a correction factor α is determined, such that the productivity index IP for a shear thinning foam can be written:

IP=α··IP₀ (18)

where IP₀ is the productivity index determined in the previous [symbol] for which the injected fluid is considered to be a Newtonian fluid, and α is a correction factor that is a function of at least one characteristic of the fluid injected into the injection well (that is the aqueous solution containing a gas in foam form).

According to an implementation of the invention, Equation (18) can be written as follows:

$$IP = {IP}_{0} \frac{1 + \frac{\text{?}}{\text{?}} F M ( {r}_{w} )}{1 + \frac{{λ}_{g}}{{λ}_{w}} F M} \\ \text{?} \text{indicates text missing or illegible when filed} \qquad ( 19 )$$

where λ_{g} and λ_{w} respectively designate a mobility associated with the gas phase (which can be expressed as the ratio of the gas permeability to the gas viscosity) and a mobility associated the water phase (which can be expressed as the ratio of the water permeability to the water viscosity), r_{w} is the (real) radius of the well, FM(r_{w}) is the near-well gas mobility reduction functional calibrated as described in step 2 above, and

$$\overline{\frac{{λ}_{g}}{{λ}_{w}} FM}$$

is the average of the product of the mobility reduction functional by the ratio of the mobilities associated with the gas phase and the aqueous phase and the average is estimated in the well cell (it can for example be estimated by integration between the well radius and the well cell). Thus, the correction factor according to this implementation of the invention allows integrating the viscosity variability of the injected fluid into the average worked out in the well cell, which allows the productivity index of the injection well to be correctly calculated. Indeed, the productivity index corrected for the shear thinning effects depends on the values of functional FM and on the mobilities of the injected fluids.

According to an implementation of the invention, where it is assumed that mobilities λ_{g} and λ_{w} are directly controlled by foam quality ƒ_{g}, which is constant because the laboratory measurements were performed at a constant injection rate, a productivity index IP corrected for the shear thinning properties of the foam can be determined with a formula of the type:

$$IP = {IP}_{0} \frac{1 + \frac{{f}_{g}}{λ - {f}_{g}}}{1 + \frac{{λ}_{g}}{{λ}_{w}} FM} . \qquad ( 20 )$$

According to another implementation of the invention, where it is assumed that the F̅M̅<<1 for r_{w}≤r≤r′₀, a productivity index IP is corrected for the shear thinning properties of the foam which can be determined with a formula:

$$IP = {IP}_{0} ( 1 + \frac{{f}_{g}}{1 - {f}_{g}} ) \qquad ( 21 )$$

According to a variant embodiment of the invention, the productivity index determined according to any one of the implementations described above can further be corrected by a numerical flow simulation performed on a gridded representation whose cell dimension, at least around the well, is determined to reproduce the local bottomhole flow velocities. More precisely, by use of a numerical flow simulation performed on a gridded representation whose cell dimension, at least around the well is determined to reproduce the local bottomhole flow velocities, a productivity index is determined for the reference well and an additional correction is applied to the productivity index determined as described above, which is a function of the numerically predicted productivity index. According to an implementation of the invention, a multiplier is used to numerically correct the productivity index determined as described above.

5. Hydrocarbon Exploitation

This step determines at least one development scheme for the hydrocarbons contained in the formation. In general terms, a development scheme comprises a number, a geometry and locations (position and spacing) for the injection and production wells. In the case of enhanced oil recovery by injection of a gas in foam form, the type of gas injected into the formation studied and/or the type of foaming agent added to this gas, or the amount of foaming agent, can be specified. A hydrocarbon reservoir development scheme must for example enable a high rate of recovery of the hydrocarbons trapped in the geological reservoir, over a long development duration, and require a limited number of injection and/or production wells. The production thus predefines evaluation criteria according to which a development scheme for the hydrocarbons contained in the reservoir is considered to be effective enough to be implemented for the reservoir being studied.

According to the invention, determining the development scheme for the hydrocarbons in the formation is achieved by use of a flow simulator, of the foam displacement model determined as described in steps 1 to 3, and of the productivity indices determined in step 4. An example of a flow simulator (also referred to as reservoir simulator) allows a foam displacement model to be taken into account is the PumaFlow® software (IFP Energies nouvelles, France). According to the invention, at any time t of the simulation, the flow simulator solves all of the flow equations specific to each cell of the gridded representation of the reservoir and delivers values solutions to the unknowns (saturations, pressures, concentrations, temperature, etc.) predicted at this time t. This solution provides knowledge of the amounts of oil produced and of the state of the reservoir (distribution of pressures, saturations, etc.) at the time being considered. According to an embodiment of the invention, various development schemes can be defined for the hydrocarbons of the reservoir being studied, and the flow simulator including the foam displacement model determined at the end of step 3 and the productivity indices determined in step 4 allows estimation, for example of the amount of hydrocarbons produced according to each of the various development schemes, the representative curve of the evolution of production with time in each production well, etc.

Then, once the development scheme is determined, the hydrocarbons trapped in the petroleum reservoir are exploited in accordance with this development scheme, notably at least by drilling the injection and production wells of the development scheme thus determined, to produce the hydrocarbons, and by setting up the production infrastructures required for development of this reservoir. Exploitation of the hydrocarbons trapped in the reservoir is further achieved by injecting a foam having properties (foaming agent type, concentration, foam quality for example) considered to be the most favorable for recovery of the hydrocarbons trapped in the reservoir, after flow simulation for different values of these properties.

It is understood that the development scheme can evolve during the exploitation of the hydrocarbons of a reservoir, according to the reservoir-related knowledge acquired during development and to improvements in the various technical fields involved in the exploitation of a hydrocarbon reservoir (advancements in the field of drilling, enhanced oil recovery for example).

It is clear that the method according to the invention comprises steps carried out by use of equipment (a computer workstation for example) including data processing (a processor) and data storage (a memory, in particular a hard drive), as well as an input/output interface for data input and method results output.

In particular, the data processing is configured for carrying out simulation of the flows within the reservoir studied, using a flow simulator according to the invention as described above.

Furthermore, the invention concerns a computer program which is downloadable from a communication network and at least one of recorded on a computer-readable medium and processor executable, comprising program code instructions for implementing the method as described above, when the program is executed on a computer.

### Examples

The features and advantages of the method according to the invention will be clear from reading the application example hereafter.

The reservoir considered for this application example is in North Africa. Its main characteristics, notably petrophysical, are given in Table 1. After petrophysical characterization, it appears that this reservoir can be modelled by a homogeneous isotropic distribution of its flow properties (notably porosity and permeability).

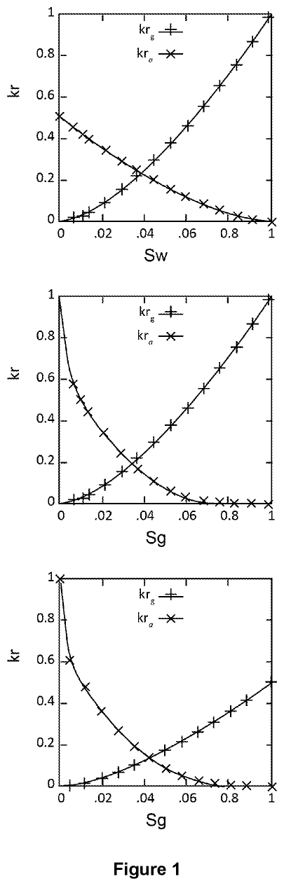

The thermodynamic properties of the fluids in place are given in Table 2. The fluid-rock system is an oil-water system without gas present under the reservoir conditions. The reservoir is at all times at pressures above the bubble point pressure. The conventional gas, water and oil relative permeability curves kr relative to this reservoir are given in FIG. 1.

TABLE 1

| | |
|---|---|
| Depth (m) | 3178 |
| Oil saturation of the perforated geologic layer (—) | 0.2 |
| Average porosity (—) | 0.08 |
| Average permeability (mD) | 30 |
| Thickness (m) | 25 |
| Water-oil contact (m) | 3380 |
| Temperature (° C.) | 80 |
| Rock compressibility (bar⁻¹) | 7E−05 |
| Initial pressure (bar) | 180 bar at 3200 m |

TABLE 2

| | Density | Viscosity |
|---|---|---|
| Fluid | (kg/m³) | (cP) |
| Oil | 865 | 1.6 |
| Water | 1000 | 0.37 |
| Gas | 0.987 | 0.0135 |

Foam injection into the reservoir being studied is achieved by in-situ co-injection of CO₂ and a brine containing a surfactant.

An injection well and a production well have been drilled in this reservoir. The injection well, controlled by constant flow rate (150 m³/day) and foam quality (80%), is perforated between 3178 and 3203 m.

For this example, we define a displacement model that is a function of a mobility reduction factor and of a single interpolation function, relative to the injection rate (function F₄). A series of measurements as described in step 1 are performed on a rock sample from this reservoir, for different injection rate values. The results of these measurements are given in Table 3. The measurements of the pressure drops with and without foam were performed at constant quality and variable injection rate (CO₂ and brine). It is noted that the pressure drop ratio is maximum for an injection rate value of 36.

TABLE 3

| | | | | |
|---|---|---|---|---|
| Injection rate (cc/h) | 18 | 36 | 48 | 72 |
| Pressure drop with foam (bar) | 91 | 770 | 925 | 1170 |
| Pressure drop without foam (bar) | 25 | 63 | 89 | 136 |
| Pressure drop ratio (—) | 3.6 | 12.2 | 10.4 | 8.6 |

According to the invention, from the measurements of the pressure drops with and without foam performed for different injection rate values and notably from the maximum pressure drop ratio value, the values of the constants of interpolation function F₄ relative to the injection rate and the value of the (so-called optimal) mobility reduction factor are determined as described in step 3 above. The values of the mobility reduction factor M_{mod}^{opt}, of constant e_{c} and the reference value of the capillary number N_{c}* are given in Table 4.

TABLE 4

| M_{mod}^{opt} | e_{c} | N*_{c} |
|---|---|---|
| 22000 | 0.5 | 1E−12 |

The foam displacement model as calibrated can then be used in a flow simulator in order to determine a development scheme for this reservoir.

By way of illustration, it is shown hereafter that the method according to the invention, due to the correction of its productivity index to account for the shear thinning properties of the foam, enables reliable estimation of the bottomhole pressure, even when using a conventional resolution grid. In the case of the reservoir being studied, this is of particular interest since the safety threshold for this reservoir is 500 bar, a pressure beyond which there is a risk of formation fracture.

Thus, for this example, an assessment of when a limit bottomhole pressure of 500 bar can be reached is to be made. An injection period of 200 days is studied, for a constant injection concentration of 0.5 g/L foaming agent. This type of modelling is referred to as injection test in the trade.

A first grid representative of the reservoir near-wellbore region, of conventional resolution, is constructed. More precisely, it is a 1D radial grid made up of concentric cells distributed in a first 22 km-radius crown where the cells are spaced 50 m apart, and in a second crown extending from 22 km to 100 km with respect to the center of the injection well being considered, made up of concentric cells spaced 100 m apart. Such cell dimensions are conventional in reservoir simulation.

A second 1D radial-geometry grid of very high resolution is also constructed. More precisely, this grid is made up of concentric cells distributed in a first crown up to a radial distance of 200 m with respect to the center of the well and where the cells are spaced 10 cm apart, a second crown extending up to a radial distance of 2000 m with respect to the center of the well and where the cells are spaced 1 m apart, a third crown extending up to a radial distance of 20 km with respect to the center of the well and where the cells are spaced 10 m apart, and a fourth crown extending up to a radial distance of 100 km with respect to the center of the well and made up of concentric cells spaced 100 m apart. Such a very high resolution grid cannot be used on a routine basis because the computing time of a reservoir simulation with this type of grid is very long. In the present case, the computing time for modelling the flows in the second grid is 18 times greater than the computing time required for modelling the flows in the first grid.

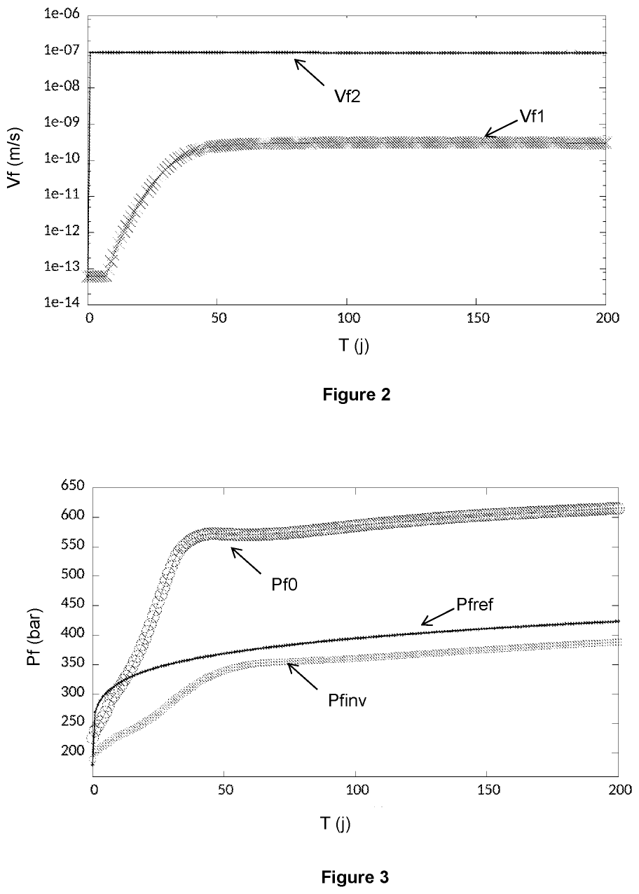

FIG. 2 shows an estimation of the evolution over time T of the bottomhole gas phase flow velocities Vf, estimated on the first grid (curve Vf1) and on the second grid (curve Vf2). It is noted that the gas phase velocity values in the well cells are very different depending on the grid resolution, which is due to the shear thinning properties of the injected foam.

The evolution of the bottomhole pressure in the injection well is first simulated by the PumaFlow® flow simulator (IFP Energies nouvelles, France), of the first grid (conventional resolution) and of an injection well productivity index determined by disregarding the shear thinning properties of the foam. More precisely, the evolution of the bottomhole pressure in the injection well is simulated using as the flow simulator input a productivity index according to the conventional Peaceman formula. Curve Pf0 in FIG. 3 shows the evolution over time T of the bottomhole pressure Pf in the injection well, obtained with the productivity index according to the prior art.

According to the invention, the productivity index determined according to the prior art is corrected using the formula according an implementation of the invention described in Equation (21), i.e.:

$$IP = {IP}_{0} \times ( 1 + \frac{{f}_{g}}{1 - {f}_{g}} ) = {IP}_{0} ( 1 + \frac{0.8}{1 - 0.8} ) = 5 {IP}_{0}$$

Thus, the correction factor to be applied to Peaceman's productivity index is therefore 5 for a foam quality of 80%. The evolution of the bottomhole pressure in the injection well is then simulated by the Puma Flow® flow simulator (IFP Energies nouvelles, France), of the first grid (conventional resolution) and of the injection well productivity index corrected so as to take account of the shear thinning properties of the foam. FIG. 3 shows curve Pfinv representative of the evolution over time T of the bottomhole pressure Pf obtained with the productivity index corrected according to the invention.

FIG. 3 further shows a curve Pfref representative of the evolution over time T of the bottomhole pressure Pf obtained by a productivity index according to the prior art, but determined for the second grid, i.e. the grid of very fine resolution. This curve can be considered as a reference curve, as close to the real in-situ conditions as possible.

Comparing curves Pfinv, Pf0 and Pfref of FIG. 3 allows to conclude that the bottomhole pressure estimation according to the invention allows approaching the reference bottomhole pressure, even when a grid of conventional resolution is used, whereas the bottomhole pressure predicted according to the prior art is very far from the reference bottomhole pressure. In particular, relying on the bottomhole pressure curve according to the prior art (curve Pf0 in FIG. 3) would lead to the conclusion that the safety threshold (500 bar) relative to the limit bottomhole pressure is reached after 29 days of injection whereas, according to the bottomhole pressure curve of the invention Pfinv, this threshold is not reached during the planned 200-day injection period, which is in fact in accordance with reference curve Pfref.

Thus, correction of the productivity index according to the invention allows obtaining reliable flow predictions by numerical flow simulation, without having to use grids of high spatial resolution. The method according to the invention therefore allows using a grid of conventional resolution for flow simulation, and thus to evaluate at a lower cost various possible development schemes for the reservoir.

Furthermore, the invention allows adapting the reservoir development scheme in consequence of the higher injectivity thus predicted, notably regarding the surface installations (pumps, centrifuges, etc.).

1.-12. (canceled)

13. A method for exploiting hydrocarbons in a reservoir, by injection of an aqueous solution containing a gas form into at least one injection well and of a flow simulator, based on a displacement model of the gas form, the displacement model being expressed as a function of a mobility reduction function of the gas, the function being expressed as a function of a mobility reduction factor of the gas and at least one interpolation function of the mobility reduction factor, the interpolation function being a function of at least one parameter relative to at least one characteristic of the foam and of at least two constants, the at least one parameter of the interpolation function corresponding to an injection rate of the gas, from at least one sample of the formation and from a gridded representation representative of the reservoir, comprising steps of:
A—determining the displacement model by determining the mobility reduction factor of the gas and the constants of the interpolation function of the displacement model, from at least pressure drop measurements performed while injecting into the at least one sample the gas in non-foaming form and the gas foam for values of the injection rate of the gas;
B—determining for each cell of the gridded representation traversed by the at least one injection well, a productivity index IP corrected for shear thinning effects of the gas foam in each cell according to a formula:
IP=α·IP₀
where IP₀ is a productivity index determined with an assumption that the aqueous solution containing the gas in foam which is a Newtonian fluid, and α is a correction factor that is a function of at least one characteristic of the aqueous solution containing the gas in the gas foam; and
C—determining from the displacement model, the flow simulator, the gridded representation and the productivity indices determined for each cell of the gridded representation traversed by the injection well, a development scheme for the reservoir; and
D—exploiting the hydrocarbons.

14. A method as claimed in claim 13 wherein, from measurements of a relative permeability to the gas in non-foaming form and measurements of a relative permeability to the aqueous phase of the solution within step A are carried out by substeps of:
i. determining for each of the interpolation functions, carrying out injection, into the at least one sample of the gas in a non-foaming form and in the gas foaming form for values of the parameter relative to the function, measuring respectively a pressure drop with foam and a pressure drop without foam for each of the values of the parameter relative to the function. At least one value of the parameter relative to the interpolation function maximizing a ratio between the pressure drops without foam and the pressure drops with foam measured for the interpolation function;
ii. determining from at least the pressure drop measurements with foam and without foam performed for the values of the parameters relative to the functions maximizing a ratio of the measurements of a conventional relative permeability to the gas in non-foaming form to the measurements of conventional relative permeability to the aqueous phase, the mobility reduction factor and calibrating the constants of each of the interpolation functions.

15. A method as claimed in claim 14 wherein, after step i) has been performed for each of the interpolation functions and before step ii), the gas in non-foaming form and the gas in foam form are injected into the at least one sample according to the values of each of the parameters maximizing the ratio, measuring a pressure drop with foam and a pressure drop without foam respectively for all values of the parameters maximizing the ratio of the pressure drop, and step ii) is carried out from, in addition to the pressure drops measurements with and without foam performed for all of the values of the parameters maximizing the ratio of the pressure drops.

16. A method as claimed in claim 13, wherein the foam displacement model is expressed as:
k_{rg}^{FO}(S_{g})=FMk_{rg}(S_{g})
where k_{rg}^{FO}(S_{g}) is relative permeability to the gas foam for a given gas saturation value S_{g}, k_{rg}(S_{g}) is a relative permeability to the non-foaming gas for the gas saturation value S_{g}, and FM is a function expressed as:
$$FM = \frac{1}{1 + ( {M}^{opt} - 1 ) * {Π}_{k} {F}_{k}}$$
where M^{opt} is the mobility reduction factor of the gas and Fₖ is one of the interpolation functions, with k≥1.

17. A method as claimed in claim 14, wherein the foam displacement model is expressed as:
k_{rg}^{FO}(S_{g})=FMk_{rg}(S_{g})
where k_{rg}^{FO}(S_{g}) is relative permeability to the gas foam for a given gas saturation value S_{g}, k_{rg}(S_{g}) is a relative permeability to the non-foaming gas for the gas saturation value S_{g}, and FM is a function expressed as:
$$FM = \frac{1}{1 + ( {M}^{opt} - 1 ) * {Π}_{k} {F}_{k}}$$
where M^{opt} is the mobility reduction factor of the gas and Fₖ is one of the interpolation functions, with k≥1.

18. A method as claimed in claim 15, wherein the foam displacement model is expressed as:
k_{rg}^{FO}(S_{g})=FMk_{rg}(S_{g})
where k_{rg}^{Fo}(S_{g}) is relative permeability to the gas foam for a given gas saturation value S_{g}, k_{rg}(S_{g}) is a relative permeability to the non-foaming gas for the gas saturation value S_{g}, and FM is a function expressed as:
$$FM = \frac{1}{1 + ( {M}^{opt} - 1 ) * {Π}_{k} {F}_{k}}$$
where M^{opt} is the mobility reduction factor of the gas and Fₖ is one of the interpolation functions, with k≥1.

19. A method as claimed in claim 13, wherein there are four interpolation functions and the parameters of the functions are a foaming agent concentration, a water saturation, an oil saturation and the injection rate of the gas.

20. A method as claimed in claim 14, wherein there are four interpolation functions and the parameters of the functions are a foaming agent concentration, a water saturation, an oil saturation and the injection rate of the gas.

21. A method as claimed in claim 15, wherein there are four interpolation functions and the parameters of the functions are a foaming agent concentration, a water saturation, an oil saturation and the injection rate of the gas.

22. A method as claimed in claim 16, wherein there are four interpolation functions and the parameters of the functions are a foaming agent concentration, a water saturation, an oil saturation and the injection rate of the gas.

23. A method as claimed in claim 17, wherein there are four interpolation functions and the parameters of the functions are a foaming agent concentration, a water saturation, an oil saturation and the injection rate of the gas.

24. A method as claimed in claim 18, wherein there are four interpolation functions and the parameters of the functions are a foaming agent concentration, a water saturation, an oil saturation and the injection rate of the gas.

25. A method as claimed in claim 14, wherein the constants of at least one of the interpolation functions are calibrated by a least-squares method, based on an iterative minimization of an objective function.

26. A method as claimed claim 14, wherein the productivity index IP₀ of the injection well is determined with Peaceman's formula.

27. A method as claimed in claim 26, wherein the productivity index a IP₀ is determined by an assumption that the aqueous solution containing the gas in form foam is a Newtonian fluid according to a formula:
$${IP}_{0} = \frac{2 π hk}{ln ( \frac{{r}_{o}^{2}}{{r}_{w}} )}$$
where r_{w} is a radius of the injection well, h is a height of the cell, k is permeability of the porous medium of the reservoir and r₀′ is an equivalent radius of the cell traversed by the well in a radial-geometry gridded representation.

28. A method as claimed in claim 27, wherein the equivalent radius r⁰′ of the cell traversed by the well is defined as:
$$P ( r ) = {P}_{0} + \frac{μ Q}{2 π hk} ln ( \frac{r}{{r}_{o}^{′}} ) with P ( {r}_{0}^{′} ) = {P}_{0}$$
where P represents evolution of pressure as a function of radial distance r, P₀ is pressure assigned to the cell traversed by the well, Q is an injection rate of the gas and μ is a viscosity of the gas.

29. A method as claimed in claim 13, wherein the correction factor is expressed with a formula:
$$α = \frac{1 + \frac{{λ}_{g} ( {r}_{w} )}{{λ}_{w} ( {r}_{w} )} FM ( {r}_{w} )}{1 + \frac{{λ}_{g}}{{λ}_{w}} FM}$$
where λ_{g} is a mobility associated with the gas phase, λ_{w} is a mobility associated with the aqueous phase, r_{w} is a radius of the well, FM(r_{w}) is the gas mobility reduction function to a radius of the well, and
$$\overline{\frac{{λ}_{g}}{{λ}_{w}} FM}$$
is an average of the product of the mobility reduction function of the gas by a ratio of the mobilities associated with a gas phase and an aqueous phase with an average being estimated in a cell traversed by the well.

30. A method as claimed in claim 13, wherein the correction factor is expressed with a formula:
$$α = \frac{1 + \frac{{f}_{g}}{1 - {f}_{g}}}{1 + \overline{\frac{{λ}_{g}}{{λ}_{w}} FM}}$$
where λ_{g} is a mobility associated with a gas phase, λ_{w} is a mobility associated with an aqueous phase,
$$\overline{\frac{{λ}_{g}}{{λ}_{w}} FM}$$
is an average of a product of the mobility reduction function of the gas by the ratio of the mobilities associated with the gas phase and the aqueous phase, an average being estimated in the cell traversed by the well, and ƒ_{g} is quality of foam.

31. A method as claimed in claim 13, wherein the correction factor is expressed with a formula:
$$α = 1 + \frac{{f}_{g}}{1 - {f}_{g}}$$
where ƒ_{g} is a quality of foam.

32. A method as claimed in claim 14, wherein the correction factor is expressed with a formula:
$$α = 1 + \frac{{f}_{g}}{1 - {f}_{g}}$$
where ƒ_{g} is a quality of foam.
